(19) United States
(12) Patent Application Publication
(10) Pub. No.: US 2007/0151455 A1
(43) Pub. Date: Jul. 5, 2007

(54) CLEANING DEVICE

(76) Inventor: Peter Jon Gates, Worongary (AU)

Correspondence Address: MOORE & VAN ALLEN PLLC, P.O. BOX 13706, Research Triangle Park, NC, 27709, US

(21) Appl. No.: 11/428,872

(22) Filed: Jul. 6, 2006

(30) Foreign Application Priority Data
Jul. 6, 2005 (AU) 2005903573
Mar. 29, 2006 (AU) 2006901591

(51) Int. Cl. B03C 3/00

(52) U.S. Cl. 96/28

(57) ABSTRACT

A cleaning device for cleaning an ionising electrode in an electrostatic separator, the device comprising a cleaner for removing dust and other particulate matter from at least a portion of the electrode.

### FIELD OF THE INVENTION

The present invention relates to a cleaning device for cleaning an ionising electrode in an electrostatic separator, and to an electrostatic separator comprising such a cleaning device.

### BACKGROUND OF THE INVENTION

The separation of different particles from mined ore may occur by a variety of different processes. One such process involves separating the particles of individual particle species based upon their different electrical properties. Typical equipment which are used in separating particles in this process include high tension electrostatic roll separators (HTR), electrostatic plate and screen static field separators (ESP and ESS) and triboelectric separators.

Generally, HTR separators utilise an electrically grounded roll that transports the particles through a high voltage ionising field (corona) that charges the particles by ion bombardment. Particles with high conductivity then lose much of their charge to the earthed roll and are subsequently thrown from the surface of the roll by. centrifugal and gravity forces. Particles with lower conductivity remain pinned to the roll surface and are transported further around the roll before their charge either dissipates and they are thrown off the roll or are removed by either a mechanical means (a brush for example) or a high voltage AC wiper. The particles are thus separated by collecting those particles which are thrown off or removed from the roll at different positions.

The high voltage ionising field which charges the particles may be generated by an ionising electrode.

HTR separators are typically operated continuously over long periods of time, up to weeks or months. The ionising electrode has to be replaced periodically as a result of oxidation of the wire which may cause embrittlement and breakage of the wire. Replacement of the ionising electrode requires the HTR separator to be temporarily shut down. Importantly, it is noted that contamination of the wire results in efficiency loss of the separator and at the same time an increase in the power demand for the ionising electrode. This increase in power demand directly adds to the oxidation rate of the wire necessitating more frequent wire changes. This in turn results in more frequent shut downs for wire replacement, thereby reducing the process and economic efficiency of the separator and of the entire plant as well.

### SUMMARY OF THE INVENTION

According to a first aspect of the present invention, there is provided an electrostatic separator for separating different components of a mixture of particles on the basis of the electrical conductivity of the different components, the separator comprising

an ionising electrode for electrostatically charging the mixture of particles,

an electrically conductive surface for receiving the mixture of particles, to which the particles may loose their charge, and

a cleaning device for cleaning the ionising electrode,

wherein the different components of the mixture of charged particles are separable after a period of contact with the surface.

In an embodiment, the cleaning device is operable during operation of the separator.

In an embodiment, the ionising electrode has a charge of greater than 10 kV.

In an embodiment, the ionising wire has a charge in the range of 20 to 35 kV, preferably approximately 30 kV.

The charge of the ionising electrode may be positive or negative.

In an embodiment, the separator also comprises an automated system for operating the cleaning device.

In another embodiment, the separator also comprises a remote controller for remotely activating operation of the cleaning device.

The cleaning device may be operated continuously or intermittently.

In an embodiment, the automated system comprises a controller which activates operation of the cleaning device when the performance of the separator falls to a predetermined level.

The separator may comprise multiple ionising electrodes and multiple cleaning devices. The automated system, preferably, operates the multiple cleaning devices.

In an embodiment, the electrically conductive surface is movable past the ionising electrode.

In an embodiment, the electrostatic separator also comprises a cylindrical roll, wherein the electrically conductive surface comprises the surface of the roll.

In an embodiment, the electrostatic separator is a high-tension roll (HTR) separator.

In an embodiment, the electrostatic separator also comprises a feeder for feeding the mixture of particles onto the surface.

In an embodiment, the electrostatic separator also comprises at least one static plate, for retaining the charge of the mixture of particles charged by the ionising electrode.

In an embodiment, the at least one static plate is of the same polarity as the ionising electrode.

In an embodiment, the at least one static plate has a charge of greater than 10 kV, preferably approximately 30 kV.

In an embodiment,.the at least one static plate comprises a glass plate.

According to a second aspect of the present invention, there is provided a cleaning device for cleaning an ionising electrode in an electrostatic separator, the device comprising a cleaner for removing dust and other particulate matter from at least a portion of the electrode.

In an embodiment, the cleaning device is operable during operation of the ionising electrode.

In an embodiment, the cleaning device also comprises an actuator for moving the cleaner along at least a portion of the electrode.

In another embodiment, the cleaner comprises a polarity reversal apparatus for temporarily reversing the polarity on the ionising electrode.

In an embodiment, the cleaning device comprises a charge protector for acting against the dissipation of the voltage or potential from the ionising electrode through the cleaning device.

In an embodiment, the charge protector comprises electrical insulation from the ionising electrode.

In an embodiment, the cleaner comprises a member for contacting the ionising electrode.

In an embodiment, the member is in the form of an arm.

In an embodiment, the arm extends downwardly from the actuator.

In another embodiment, the member may be in any other suitable form for contacting the electrode such as a rotatable brush or a wiper.

In an embodiment, the arm comprises a slot for receiving the ionising electrode.

In an embodiment, the member is manufactured from an electrically non-conductive material. Thus, the member is the charge protector which prevents discharge from the ionising electrode.

In an embodiment, the slot comprises two side walls and an end wall.

In an embodiment, the end wall of the slot is curved.

In an embodiment, the slot is arranged to have at least portions of the end wall and at least portions of the side walls contacting the surface of the ionising electrode.

In an embodiment, the slot is arranged to have at least a portion of one of the side walls contacting at least a portion of the surface of the ionising electrode facing generally in the direction of an electrically conductive surface of the separator.

In an embodiment, the member comprises a felt or similar soft material pad for wiping the ionising electrode.

In an embodiment, the pad is arranged to wrap around a portion of the ionising electrode.

In an embodiment, the pad is located inside the slot.

In another embodiment, the pad is located on the end of the member.

In an embodiment, the member is arranged whereby, its weight does not significantly bear on the ionising electrode thereby avoiding movement of the ionising electrode towards a roll of the separator.

In another embodiment, the cleaner comprises a non-contact apparatus for cleaning the ionising electrode.

In an embodiment, the non-contact apparatus comprises a jet of high pressured air.

In an embodiment, the.actuator comprises any suitable pneumatic, magnetic, electric, manual or other suitable actuator.

In an embodiment, the actuator comprises a pneumatic actuator.

In an embodiment, the actuator comprises a tube and a piston, located inside the tube.

In an embodiment, the piston has a close fit with the internal walls of the tube.

In an embodiment, the cleaner is connected to the piston.

In an embodiment, the actuator comprises first and second cables connecting either end of the piston to opposing sides of the cleaner.

In an embodiment, the actuator also comprises an air deliverer for delivering air to either end of the tube to move the piston towards the opposing end of the tube.

In an embodiment, the air deliverer comprises first and second air supply conduits, fluidly connected to opposing ends of the tube.

In an embodiment, the actuator also comprises first and second rollers located at either end of the tube, the first and second cables extending around respective first and second rollers.

In an embodiment, the actuator moves the cleaner along the entire length of the ionising electrode.

In another embodiment, the cleaning device may comprise a transfer apparatus for transferring the ionising electrode from a first position to a second position, past the cleaner of the cleaning device. In this embodiment, the cleaner is held stationary, with the ionising electrode being moved by the transfer apparatus.

In an embodiment, the transfer apparatus comprises a pair of spools.

In an embodiment, the ionising electrode may be spooled in either direction from one spool to the other during operation of the ionising electrode, the cleaner cleaning dust and other particulate matter from the electrode.

According to a third aspect of the present invention, there is provided an electrostatic separator comprising any one or more of the features of the electrostatic separator of the first aspect of the present invention, wherein the cleaning device comprises any one or more of the features of the cleaning device of the second aspect of the present invention.

According to a fourth aspect of the present invention, there is provided a cleaning device for cleaning an ionising electrode, the device comprising a cleaner for removing dust and other particulate matter from at least a portion of the electrode, and an actuator for moving the cleaner along at least a portion of the electrode, wherein the device is operable during operation of the ionising electrode.

### BRIEF DESCRIPTION OF THE DRAWINGS

Embodiments of the present invention will now be described, by way of example only, with reference to the accompanying drawings, in which:

FIG. 1 shows a side view of an electrostatic separator according to embodiments of the present invention;

FIG. 2A shows an end view of a cleaning device for cleaning an ionising electrode of the separator of FIG. 1 according to embodiments of the present invention;

FIG. 2B shows a view through X-X of FIG. 1 of the cleaning device according to embodiments of the present invention; and

FIG. 3 is a plan view of a transfer apparatus for transferring an ionising electrode from a first position to a second position.

### DETAILED DESCRIPTION OF EMBODIMENTS

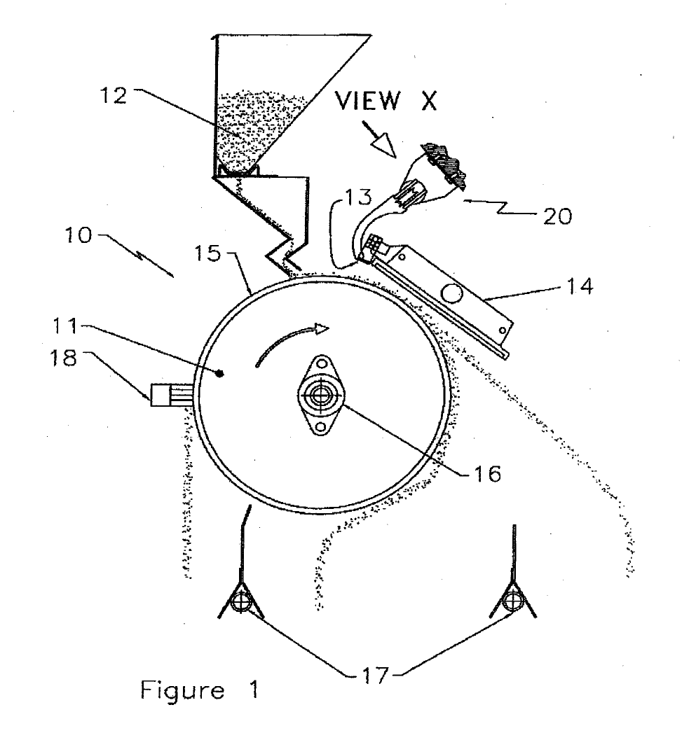

Referring firstly to FIG. 1, an electrostatic separator 10 according to embodiments of the present invention is shown. The separator 10 comprises a cylindrical roll 11 having an electrically conductive surface 15 onto which particles are fed from a material feed bin or hopper 12. The particles comprise a mixture of different components. The separator 10 also comprises an ionising electrode 13 in the form of a corona wire. Although only one ionising electrode 13 is shown in the Figures, the separator 10 may have up to six or more electrodes. The separator also comprises a static plate 14. The ionising electrode 13 and the electrostatic plate 14 are positioned just above the surface 15 of the roll 11, the surface 15 enabled to move under the ionising electrode 13 and static plate 14. The ionising electrode 13 creates an electrostatic charge or corona which electrostatically charges the particles on the surface 15 as they are carried past the ionising electrode 13. The charge may be either positive or negative and is typically 10-35 kV, in some embodiments preferably approximately 30 kV.

The roll 11 is earthed, and the charged particles are attracted towards and are pinned to the surface 15 of the roll 11. The static plate 14 is of the same polarity as the ionising electrode 13 and serves to both to decay the charge of the more conductive particles, charged by the ionising electrode 13 and repel charged particles towards the roll. Further, the static electrode 14 produces an electric field that acts upon the charged particles thereby reducing the bounce of the particles on the surface 15 of the roll 11 as the surface 15 moves and increases the efficiency of separation of the separator 10. The static plate 14 of the electrostatic separator 10 is the subject of the applicant's earlier patent application, published as WO02/09882 and generally comprises a glass plate, charged to 20-35 kV. The separator 10 may also comprise a further similar static plate (not shown) arranged adjacent to the first mentioned static plate 14.

The roll 11 also comprises a drive means 16 for rotating the roll 11. The roll 11 rotates at approximately 150-250 rpm. In the embodiment shown in FIG. 1, it rotates clockwise, but the separator 10 may be arranged so that the roll 11 rotates anti-clockwise if desired. Thus, the particles are carried on the surface 15 of the roll 11 from delivery onto the roll surface 15 from the feed bin 12 and under the ionising electrode 13 and the static plate 14 where the particles are charged. Because the roll 11 is earthed, the charged particles loose their charge to the roll 11. For different components of the mixture of particles, the loss of electrostatic charge occurs at different rates depending on the conductivity of the different particles. Thus, as the surface 15 of the roll 11 rotates under action by the drive means 16, the particle component(s) with the highest conductivity are thrown from the roll surface 15 first because they loose their charge quickly and hence no longer are attracted to the earthed roll 11. The different components of particles having different conductivities are collected in various bins 17 below the roll 11. The electrostatic separator 10 may also comprise a brush 18 (and/or an AC wiper) to remove any particles of lower conductivity from the surface 15 of the roll 11 before the surface 15 rotates back to the feed point.

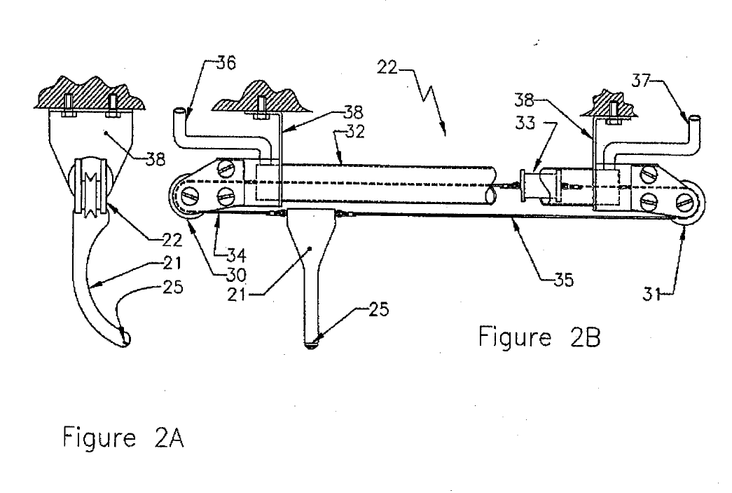

The electrostatic separator 10 also comprises a cleaning device 20 for cleaning the ionising electrode 13. If the separator 10 comprises more than one electrode 13 then each electrode may have its own cleaning device. The cleaning device 20 according to an embodiment of the present invention is shown in more detail in FIGS. 2A and 2B.

Each cleaning device 20 comprises a cleaner 21 for removing dust and other particulate matter from at least a portion of the ionising electrode 13.

It has been found that providing the ionising electrode 13 in the form of a corona wire in an electrostatic separator 10 with the cleaning device 20 improves the performance of the separator 10 by maintaining the ionising electrode 13 as a clean polished cylinder. Without detailing the exact mechanism it is understood that a reason for the improved performance is that the clean ionising electrode 13 charges the particles more uniformly and with less current demand than one coated with dust and other particulate matter because it produces a uniform ionising field as opposed to one which comprises a multitude of fine points.

Each cleaning device 20 also comprises an actuator 22 for moving the cleaner 21 along at least a portion of the ionising electrode 13.

The cleaner 21 of the cleaning device 20 comprises a member for contacting the ionising electrode 13, shown in the Figures in the form of an arm 24. The arm 24 extends downwardly from the actuator 22 and is arranged whereby its weight does not significantly bear on the ionising electrode 13. This avoids moving the ionising electrode 13 towards the roll 11. The arm 24 comprises a slot 25 located towards the lower end of the arm 24 for receiving the ionising electrode 13. The slot 25 comprises two side walls and an end wall, with the end wall of the slot 25 being preferably curved. The slot 25 is arranged, to have at least portions of the end wall and at least portions of the side walls contacting the surface of the ionising electrode 13. At least a portion of one of the side walls of the slot 25 contacts at least a portion of the surface of the ionising electrode 13 facing generally in the direction of the surface 15.

With the ionising electrode 13 positioned in the slot 25, the cleaner 21 can remove dust and other particulate matter from the ionising electrode 13 by scraping the surface of the ionising electrode 13 with the slot 25 as the actuator 22 moves the cleaner 21 along at least a portion of the length of the ionising electrode 13.

The arm 24 may also comprise a felt or similar soft material pad for wiping the ionising electrode 13. The pad is arranged to wrap around a portion of the ionising electrode 13, thus ensuring that the entire surface of the ionising electrode 13 is cleaned. The pad may be located inside the slot 25 or in another embodiment, the pad may be located on the end of the arm 24. In this embodiment it may not be necessary for the arm 24 to have the slot 25.

Importantly, the member in the form of the arm 24 which contacts the ionising electrode 13, is electrically insulated from the rest of the cleaning device 20. Thus the arm 24 is a charge protector which guards against the loss of voltage or potential from the ionising electrode 13, which could reduce the performance of the separator 10. Electrically insulating the arm 24 can be achieved by manufacturing the arm 24 of a non-conductive material. In another embodiment, the arm 24 may be insulated from the rest of cleaning device 20 by connecting the arm 24 to the actuator 22 via a portion of non-conductive material.

Alternatively, instead of electrically insulating the member in the form of the arm 24, the entire cleaning device 20 could be “electrically floating”. Accordingly, in such a configuration, electrical insulation would be required between the cleaning device 20 and the rest of the separator 10 allowing the entire cleaning device 20 to become charged to the ionising electrode 13 operating voltage. To simplify installation, in a further alternative embodiment the cleaning device 20 is mounted directly onto the static plate 14 whereby it operates at the static plate voltage.

The cleaning device 20 is operable during operation of the ionising electrode 13 and hence the separator 10 as a whole. This enables the separator 10 to operate continuously for much longer periods of times than conventional separators, because the separator 10 does not need to be shut down to clean the ionising electrode 13, nor to replace the electrode 13 as frequently as in conventional separators because by cleaning the ionising electrode 13, the life of the ionising electrode 13 is extended. Operation of the cleaning device 21 during operation of the ionising electrode 13 and hence the separator 10 is at least partly facilitated by the device 20 being electrically insulated or floating with respect to the ionising electrode 13 as described above. Thus, no electrical charge (and hence performance) is lost by the ionising electrode 13 to the cleaning device 20.

The cleaner 21 may alternatively comprise any other suitable apparatus for removing dust and other particulate matter from the ionising electrode 13, being either in contact or not in contact with the ionising electrode 13. Examples include the member being in the form of a wiper or a rotatable brush (which can be acted upon to rotate about or across the ionising electrode 13 to “scrub” the surface of the electrode 13) or a jet of high pressured air blowing on the ionising electrode 13.

Another alternative cleaner 21 to those described above is a polarity reversal apparatus which provides a brief polarity reversal on the ionising electrode 13. This causes the charged particles on the ionising electrode to be repelled away (by the reversed polarity of the electrode 13), thus cleaning the electrode 13. Such a cleaner 21 would not require the actuator 22 to move the cleaner 21 along the length of the electrode 13. Unlike the other cleaner 21 described above, the polarity reversal apparatus may require a temporary, if brief interruption of the operation of the separator 10. However, because the polarity reversal will only exist for a short duration, interruption of the operation of the separator 10 could be achieved simply by temporarily closing the feed bin 12 and stopping the feed of particulate matter onto the surface 15 of the roll 11. The roll 11 and the electrostatic plate 14 could continue to operate during this brief period in which the feed bin 12 is closed.

In one embodiment, the actuator 22 comprises first and second rollers 30, 31 located towards either end of a tube 32. The actuator 22 also comprises a piston 33, located within the tube 32 and shaped to have a close fit with the internal walls of the tube 32. The actuator 22 also comprises a first cable 34 connecting one end of the piston 33 to one side of the member in the form of the arm 24 of the cleaner 21. The actuator 22 also comprises a second cable 35 which connects the other end of the piston 33 to the other side of the arm 24. First and second cables 34, 35 extend around first and second rollers 30, 31 respectively, and are of a required length to be maintained sufficiently taught at all times. The rollers 30, 31 facilitate movement of the cables 34, 35 without the cables 34, 35 kinking or twisting.

The actuator 22 also comprises an air deliverer in the form of first and second air supply conduits 36, 37. The outlets of the first and second air supply conduits are fluidly connected to opposing ends of the tube 32 in order for pressurised air to be blown into the tube 32 at either end. Air blown into the tube 32 through the first or second air supply conduits 36, 37 provides a force on the piston 33 causing it to move along the length of the tube 32. With the cables 33, 34 connecting the piston 33 to the arm 24 of the cleaner 21, movement of the piston 33 subsequently causes movement of the cleaner 21 in the opposing direction to the movement of the piston 33. Thus, the cleaner 21 is moved up and down the length of the ionising electrode 13 by the actuator 22 by blowing air firstly through the first air supply conduit 36 into the tube 32, causing the piston 33 to move towards the second roller 31 and subsequently blowing air through the second air supply conduit 37 into the tube 32, to move the piston 33 towards the first roller 30.

The actuator 22 also comprises mounting brackets 38 for mounting the cleaning device 20 relative to the ionising electrode 13.

In another embodiment, the actuator 22 may be any other suitable actuator for moving the cleaner 21 along the length of the ionising electrode 13 such as an electric motor-driven apparatus, an arrangement of magnets carried by a piston in a tube, or even manual pushing and/or pulling of the cleaner 21.

Notably, the cleaning device 20 may be operable intermittently or continuously. The frequency of operation will be dependent on the mechanism used for the cleaner 21 as well as other factors such as the dustiness in and around the separator 10 for example. The frequency of operation of the cleaning device 20 may be hourly, daily or monthly. In one embodiment, the separator 10 comprises a remote controller for remotely activating operation of the cleaning device 20. However, in another embodiment, activation of the cleaning device 20 is done using an automated system, which operates the cleaning device 20 when the separation efficiency of the separator 10 drops below a pre-determined level. An automated system provides significant process and efficiency benefits, particularly in plants which may contain up to 50-100 separators 10, each with up to six ionising electrodes 13.

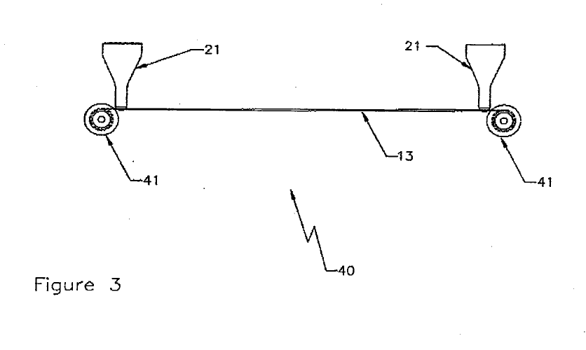

Referring to FIG. 3, in another embodiment, the cleaning device 20 may comprises a transfer apparatus 40 for transferring the ionising electrode 13 in the form of a corona wire from a first position to a second position, past the cleaner 21 of the cleaning device. In the embodiment shown in FIG. 3, the cleaner 21 comprises two arms similar to those arms discussed above (although it may only comprise one or more than two cleaners), both of which are held stationary, with the ionising electrode 13 being moved by the transfer apparatus 40. In the embodiment shown in FIG. 3, the transfer apparatus 40 comprises a pair of spools 41. The ionising electrode 13 is spooled from one spool to the other during operation of the ionising electrode 13, the cleaner 21 cleaning dust and other particulate matter from the electrode 13. Once as much of the ionising electrode 13 as possible has been wound onto one spool, the direction of rotation of the spools 41 is reversed and the ionising electrode 13 is spooled in the opposite direction.

In the preceding description of the invention and in the claims which follow, except where the context requires otherwise due to express language or necessary implication, the word “comprise” or variations such as “comprises” or “comprising” is used in an inclusive sense, ie. to specify the presence of the stated features but not to preclude the presence or addition of further features in various embodiments of the invention.

It is to be clearly understood that although prior art publication(s) are referred to herein, this reference does not constitute an admission that any of these documents forms part of the common general knowledge in the art in Australia or in any other country.

1. A cleaning device for cleaning an ionising electrode in an electrostatic separator, the device comprising a cleaner for removing dust and other particulate matter from at least a portion of the electrode.

2. A cleaning device as claimed in claim 1, wherein the cleaning device is operable during operation of the ionising electrode.

3. A cleaning device as claimed claim 1, also comprising an actuator for moving the cleaner along at least a portion of the electrode

4. A cleaning device as claimed in claim 1, wherein the cleaning device comprises a charge protector for acting against the dissipation of electrostatic charge from the ionising electrode through the cleaning device.

5. A cleaning device as claimed in claim 4, wherein the charge protector comprises insulation from the ionising electrode.

6. A cleaning device as claimed in claim 1, wherein the cleaner comprises a member for contacting the ionising electrode.

7. A cleaning device as claimed in claim 6, wherein the member is manufactured from an electrically non-conductive material.

8. A cleaning device as claimed in claim 6, wherein the member is in the form of an arm which comprises a slot for receiving the ionising electrode.

9. A cleaning device as claimed in claim 8, wherein the slot comprises two side walls and an end wall, wherein the slot is arranged to have at least portions of the end wall and at least portions of the side walls contacting the surface of the ionising electrode.

10. A cleaning device as claimed in claim 6, wherein the member comprises a felt or similar soft material pad for wiping the ionising electrode.

11. A cleaning device as claimed in claim 6, wherein the member is arranged whereby its weight does not significantly bear on the ionising electrode.

12. A cleaning device as claimed in claim 3, wherein the actuator comprises any suitable pneumatic, magnetic, electric, or manual actuator.

13. A cleaning device as claimed in claim 3, wherein the actuator comprises a pneumatic actuator.

14. A cleaning device as claimed in claim 3, wherein the actuator comprises a tube and a piston located inside the tube, the cleaner connected to the piston, wherein the actuator also comprises an air deliverer for delivering air to either end of the tube to move the piston towards the opposing end of the tube.

15. A cleaning device as claimed in claim 14, wherein the air deliverer comprises first and second air supply conduits, fluidly connected to the opposing ends of the tube.

16. A cleaning device as claimed in claim 3, wherein the actuator moves the cleaner along the entire length of the ionising electrode.

17. A cleaning device as claimed in claim 1, wherein the cleaner comprises a polarity reversal apparatus for temporarily reversing the polarity on the ionising electrode.

18. A cleaning device as claimed in claim 1, also comprising a transfer apparatus for transferring the ionising electrode from a first position to a second position, past the cleaner of the cleaning device.

19. An electrostatic separator for separating different components of a mixture of particles on the basis of the electrical conductivity of the different components, the separator comprising an ionising electrode for electrostatically charging the mixture of particles, an electrically conductive surface for receiving the mixture of particles, to which the particles may lose their charge, and a cleaning device for cleaning the ionising electrode, wherein the different components of the mixture of charged particles are separable after a period of contact with the surface.

20. An electrostatic separator as claimed in claim 19, wherein the cleaning device is operable during operation of the separator.

21. An electrostatic separator as claimed in claim 19, wherein the ionising electrode has a charge of greater than 10 kV.

22. An electrostatic separator as claimed in claim 19, also comprising a remote controller for remotely activating operation of the cleaning device.

23. An electrostatic separator as claimed in claim 19, wherein the electrically conductive surface is movable past the ionising electrode.

24. An electrostatic separator as claimed in claim 19, also comprising a cylindrical roll, wherein the electrically conductive surface comprises the surface of the roll.

25. An electrostatic separator as claimed in claim 19, also comprising at least one static plate for retaining the charge of the mixture of particles charged by the ionising electrode.

26. An electrostatic separator as claimed in claim 19, wherein the cleaning device comprises the cleaning device as claimed in claim 1.

27. A cleaning device for cleaning an ionising electrode, the cleaning device comprising a cleaner for removing dust and other particulate matter from at least a portion of the electrode, and an actuator for moving the cleaner along at least a portion of the electrode, wherein the device is operable during operation of the ionising electrode.
